(19) United States
(12) Patent Application Publication
(10) Pub. No.: US 2009/0069919 A1
(43) Pub. Date: Mar. 12, 2009

(54) INTELLIGENT MASS PRODUCTION PLANNING AND ROUTING SYSTEM

(75) Inventors: Steven C. Erickson, Rochester, MN (US); Ivory W. Knipfer, Rochester, MN (US); John W. Marreel, Rochester, MN (US); Matthew H. Zemke, Rochester, MN (US)

Correspondence Address: CAREY, RODRIGUEZ, GREENBERG & PAUL, LLP;STEVEN M. GREENBERG, 950 PENINSULA CORPORATE CIRCLE, SUITE 3020, BOCA RATON, FL, 33487, US

(73) Assignee: INTERNATIONAL BUSINESS MACHINES CORPORATION, Armonk, NY (US)

(21) Appl. No.: 11/851,531

(22) Filed: Sep. 7, 2007

(51) Int. Cl. G06F 19/00; G05B 19/418

(52) U.S. Cl. 700/97; 705/7; 705/8

(57) ABSTRACT

Embodiments of the present invention address deficiencies of the art in respect to manufacturing production and provide a method, system and computer program product for mass production planning and routing. In one embodiment of the invention, a method for mass production planning and routing can be provided. The method can include initiating a production process sequence to produce a product according to an initial routing receiving a request to change the initial routing to a new routing, dynamically comparing the initial routing to the new routing, removing each production process from the new routing that had already been completed in the initial routing, and resuming the production process sequence with the new routing.

### BACKGROUND OF THE INVENTION

1. Field of the Invention

The present invention relates to manufacturing resource planning (MRP), and more particularly to production planning and routing in an advanced MRP system.

2. Description of the Related Art

Large-scale manufacturing systems typically involve complex distributed supply and demand networks. A manufacturing facility generally includes a large number of production lines producing many products having multiple process steps in manufacturing the final product. Changes in market supply and demand can cause a great deal of uncertainty in production demand, and purchase orders frequently may need to be changed or rescheduled. If the order cannot be rescheduled or updated methodically in a timely fashion, then consequent delays in production can occur.

Solutions traditionally deployed on shop floors are inadequate for today's manufacturing environments, due to the exponential increase in shop floor processes while coping with challenging delivery goals. When there is an order change or an issue on the shop floor, visibility of how a proposed corrective action will affect other orders is necessary. Many suppliers usually invest in information systems for manufacturing planning and control. Most often, the core planning and scheduling system utilized by suppliers includes or is incorporated within an MRP system.

MRP is a well known production scheduling method based on an explosion of finished product demand using manufacturing information, such as Bill-of-Material (BOM), yield and cycle times, and inventory. Within an MRP system, when routings change based on configuration changes or new manufacturing needs, the disposition of production process sequences already in operation on the shop floor can greatly be impacted. Yet, if a production process sequence already has been initiated, the current option in the art is to manually modify the initial routing requiring the update. In consequence, known mass production procedures generally flush the pipeline of production process sequences by deleting all of the production process in the initial routing and recreating new production orders with a desired new routing. Cancelling affected orders results in loss of manufacturing work, delay in manufacturing cycle time and potential shipments.

### BRIEF SUMMARY OF THE INVENTION

Embodiments of the present invention address deficiencies of the art in respect to manufacturing production and provide a novel and non-obvious method, system and computer program product for mass production planning and routing. In one embodiment of the invention, a method for mass production planning and routing can be provided. The method can include initiating a production process sequence to produce a product according to an initial routing receiving a request to change the initial routing to a new routing, dynamically comparing the initial routing to the new routing, removing each production process from the new routing that had already been completed in the initial routing, and resuming the production process sequence with the new routing.

In another embodiment of the invention, a mass manufacturing production planning and routing method can be provided to include receiving a request to update an in-process order, filtering a subset of production process sequences affected by the update from a set of production process sequences for the in-process order, and, for each production process sequence in the filtered subset, comparing an initial routing of production processes for the production process sequence to a proposed new routing of production processes for the update for the production process sequence, removing each production process from the new routing that had already been completed in the initial routing, and resuming the production process sequence with the new routing.

In yet another embodiment of the invention, a manufacturing production planning and routing system can be provided. The system can include an MRP system configured to manage an order for a product by executing different production process sequences of production processes according to corresponding routings of the production processes. The system further can include a repository of production processes in different production sequences for producing the product in the MRP system. Finally, the system can include a mass production routing engine coupled to the MRP system and the repository. The engine can include program code enabled to update an in-process order of an initial routing of production processes both completed and uncompleted with a corresponding new routing of production processes by removing completed ones of the production processes while retaining uncompleted ones of the production processes, and to resume the in-process order with the new routing.

Additional aspects of the invention will be set forth in part in the description which follows, and in part will be obvious from the description, or may be learned by practice of the invention. The aspects of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE SEVERAL VIEWS OF THE DRAWINGS

The accompanying drawings, which are incorporated in and constitute part of this specification, illustrate embodiments of the invention and together with the description, serve to explain the principles of the invention. The embodiments illustrated herein are presently preferred, it being understood, however, that the invention is not limited to the precise arrangements and instrumentalities shown, wherein:

FIG. 1 is a pictorial illustration of a manufacturing production network incorporating an intelligent mass production planning and routing system;

FIG. 2 is a schematic illustration of an intelligent mass production planning and routing system incorporated by the manufacturing production network of FIG. 1;

FIG. 3 is a flowchart illustrating a process for criteria selection incorporated by the intelligent mass production planning and routing system of FIG. 2;

FIG. 4 is a flowchart illustrating a process for an intelligent mass production planning and routing incorporated by the intelligent mass production planning and routing system of FIG. 2; and

FIG. 5 is a flowchart illustrating a process for post-impact process flow adjustment incorporated by FIG. 4.

### DETAILED DESCRIPTION OF THE INVENTION

Embodiments of the present invention provide a method, system and computer program product for intelligent mass production planning and routing in an MRP system. In accordance with an embodiment of the present invention, upon receiving a request to update an order in process, a list of production process sequences affected by the request can be filtered from a larger list of production process sequences in the MRP system. Thereafter, for each filtered production process sequence, an initial routing implemented prior to the update request can be compared to a new proposed routing and each production process in the sequence that has already been completed in the initial routing can be removed from the new routing. Finally, the production process sequence can resume with the new routing. Thus initial routings for the affected production process sequences can be augmented by new routings while concurrently preserving prior manufacturing operations and processes that had been successfully completed.

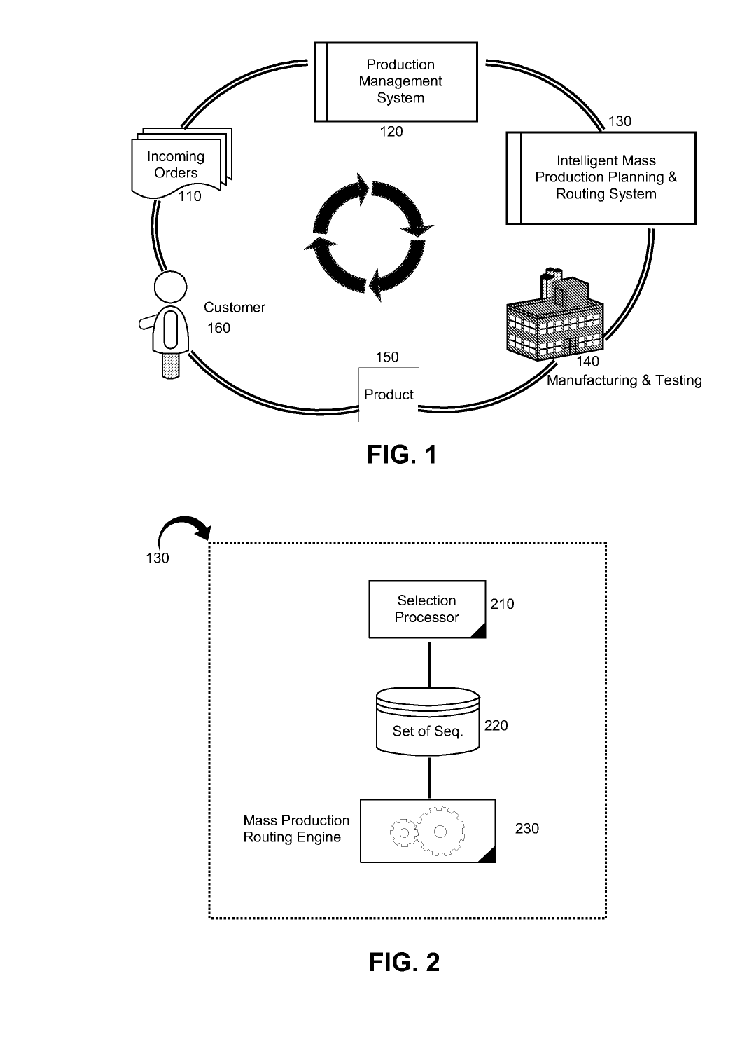

In illustration, FIG. 1 pictorially depicts a manufacturing production network incorporating intelligent mass production planning and routing. In advanced manufacturing environments where products are “built to customer order,” an incoming order 110 can be processed in production management system 120. Thereafter, intelligent mass production planning and routing 130 can be invoked to update an order from one or more initial routings to one or more new routing. During intelligent mass production and routing 130, the process routing necessary to update a product order change can be adjusted efficiently without losing manufacturing work. Thereafter, a produced product 150 can be passed through manufacturing and testing 140 and ultimately to a customer 160.

Turning now to FIG. 2, the intelligent mass production planning and routing 130 of FIG. 1 be embodied in a data processing system. The system can include a selection processor 210 coupled to a data store of production process sequences 220. The data store of production process sequences 220 in turn can be coupled to a mass production routing engine 230. In operation, in response to a request to update an order in process, the selection processor 210 can select a subset of production process sequences for the order from the data store of production process sequences 220 by utilizing at least one selection criteria filter. The selection criteria filter can, for example, filter the production process sequences according to order type, part number, production status, order priority or shipping date.

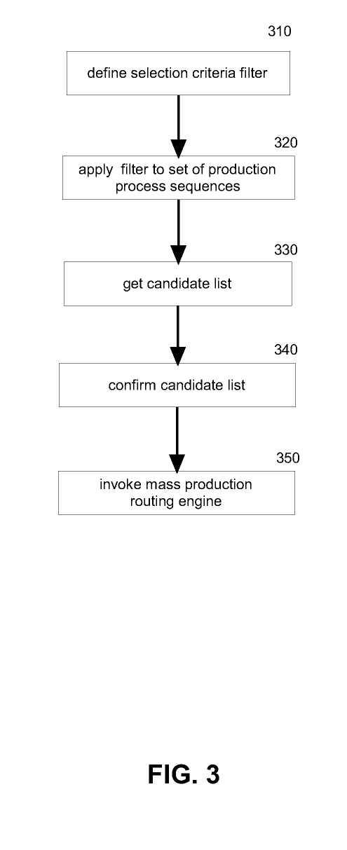

In more particular illustration, FIG. 3 is a flowchart illustrating a process for criteria selection incorporated by the intelligent mass production planning and routing system of FIG. 2. In block 310 one or more selection criteria filters can be defined. Selection criteria filters can be defined automatically by logistics software or manually defined by a user's input. A selection criteria filter can be used to filter the set of production process sequences by type of order, part number, production status, order priority, or shipping date. In block 320, an automatically or manually specified filter can be applied to sort through the set of production process sequences.

For instance, by way of example a set of production process sequences can be filtered by those orders requiring an upgrade for a particular product component. Applying the filter to the production process sequence, a candidate list of sequences can be compiled providing specific routings for the particular product components requiring an upgrade. As a result, the candidate list of sequences will necessarily include a list of sequences that may be affected by a routing change. The routing change can include, for instance, a test to prove compatibility between the particular product component requiring an upgrade and an existing product component.

In any event, in block 330 the selection processor can retrieve a candidate list which represents a set of production process sequences that are possible candidates to a potential upgrade to a product or change in a existing routing scheme. In block 340, the candidate list can be confirmed automatically or manually through user input. Then in block 350 a mass production routing engine can be invoked to automatically adjust and update routings with minimal loss of manufacturing work.

Specifically, referring again to FIG. 2, the mass production routing engine 230 can dynamically compare an initial routing for the order to a new routing for each of the selected production process sequences. Based upon the comparison, the mass production routing engine 230 can remove each production process from the new routing that had already been completed in the initial routing. Once the pertinent production processes have been removed from the new routing, the production process sequence can resume using the new routing as presented by the mass production routing engine 230.

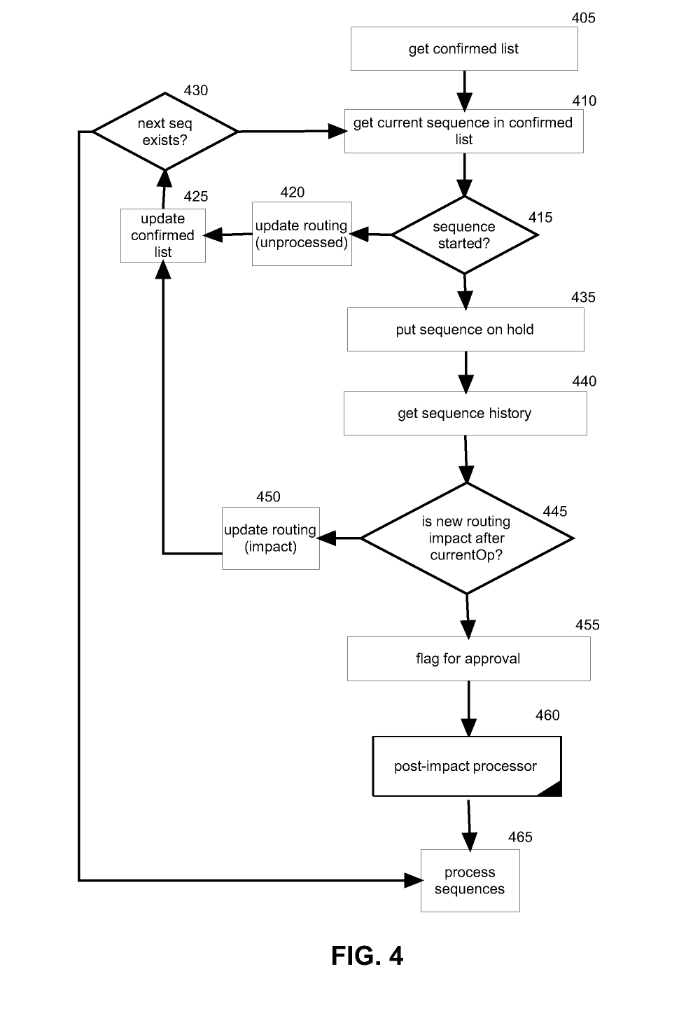

In further illustration, FIG. 4 is a flowchart showing a process for intelligent mass production planning and routing as performed by the mass production routing engine of FIG. 3. Beginning in block 405, the engine can retrieve a filtered and confirmed list of production process sequences. Using the list, the engine can loop iteratively through each of the production process sequences in the list. Specifically, in block 410, a first production process sequence in the confirmed list can be selected for processing and in decision block 415 if the production process sequence has not already been started, then in block 420 the engine can be enabled to purge the old routing and replace the old routing with the proposed new routing. Consequently in block 425, the engine can update the confirmed list and in block 430, it can check whether another next production process sequence is in the list and loop through sequence by sequence. If there are no more production process sequences to check, in block 470 the production process sequences can be processed and the necessary updates to the routings can be implemented.

In decision block 415, if a current production process sequence in the confirmed list has already started then in block 435, the current production process sequence can be put on ‘hold’ to ensure no further changes are made while active at a workstation. Next in block 440, the sequence history can be retrieved and adjusted to the next appropriate process or operation to continue manufacturing work. In decision block 445, if the new routing impact is after the current operation in progress, then there is no concern for any loss of production activity since the new routing impact will not affect the sequence history. In this scenario, block 450 can be implemented where the new routing can be appended from the position of current operation in the old routing. Next in block 425 the engine can update the confirmed list and in block 430 it can enter the loop to see whether another next production process sequence exists in the confirmed list. If there are no more production process sequences that exist, in block 470, the production process sequence can be processed and the necessary updates to the routings can be implemented.

In decision block 445, if the new routing impact occurs before the current operation in progress, in other words, would have an affect on processes that were completed up until the current operation, then in block 455, the production process sequence can be flagged for approval. Approval can be automated by logistics software or manually approved by a user's input. Next in block 460, the post-impact processor flow adjustment can be invoked to handle the proposed new routing without having a detrimental effect on production activity. Consequently, in block 365 the production process sequence is processed and released.

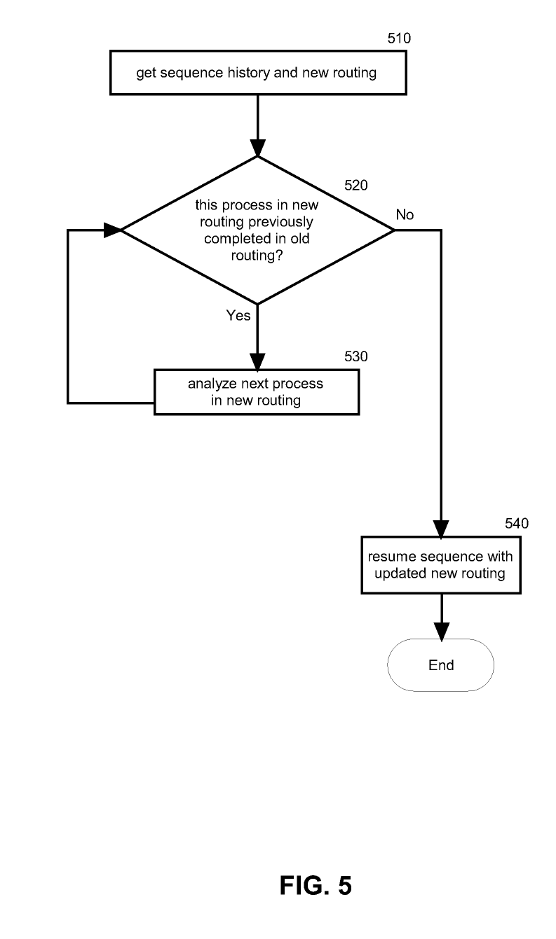

In yet further illustration, FIG. 5 is a flowchart illustrating a process for post-impact process flow adjustment. In block 510 the sequence history and new routing can be retrieved. In order to determine which processes/operations were previously successfully completed, the new routing can be dynamically compared to the old routing by comparing each process in the old/initial routing and the new routing to find a match. In decision block 520, if there is a match, then the matching process can be removed from the new routing since it was already completed in the initial routing and in block 530 the next process in the new routing can be analyzed to determine whether it matches a process in the initial routing. If this process was not previously implemented in the old routing, then this process is kept in the new routing, and in block 540 the production process sequence can resume with the adjusted new routing that does not contain processes that have already been completed in the initial routing.

Optionally, multiple different orders in a set of released orders can be selected. For example, the selected set of released orders can be selected by way of a filter applied to the released orders. Once the set of released orders has been selected, a new set of routings can be resolved for each of the released orders in the set as compared to existing routings for each of the released orders in the set. In this way, the new set of routings can be produced without requiring an order explosion or a release from an MRP or order management system of each of the released orders in the set.

Embodiments of the invention can take the form of an entirely hardware embodiment, an entirely software embodiment or an embodiment containing both hardware and software elements. In a preferred embodiment, the invention is implemented in software, which includes but is not limited to firmware, resident software, microcode, and the like. Furthermore, the invention can take the form of a computer program product accessible from a computer-usable or computer-readable medium providing program code for use by or in connection with a computer or any instruction execution system.

For the purposes of this description, a computer-usable or computer readable medium can be any apparatus that can contain, store, communicate, propagate, or transport the program for use by or in connection with the instruction execution system, apparatus, or device. The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution. Input/output or I/O devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

We claim:

1. A mass manufacturing production planning and routing method comprising:
initiating a production process sequence to produce a product according to an initial routing;
receiving a request to change the initial routing to a new routing;
dynamically comparing the initial routing to the new routing;
removing each production process from the new routing that had already been completed in the initial routing; and
resuming the production process sequence with the new routing.

2. The method of claim 1, further comprising:
selecting a set of released orders from amongst a plurality of released orders; and,
for each one of the selected released orders in the set, dynamically comparing an initial routing to a new routing, removing every production process in a corresponding production process sequence from the new routing that had already been completed in the initial routing, and resuming the production process sequence with the new routing.

3. A mass manufacturing production planning and routing method comprising:
receiving a request to update an in-process order;
filtering a subset of production process sequences affected by the update from a set of production process sequences for the in-process order; and,
for each production process sequence in the filtered subset, comparing an initial routing of production processes for the production process sequence to a proposed new routing of production processes for the update for the production process sequence, removing each production process from the new routing that had already been completed in the initial routing, and resuming the production process sequence with the new routing.

4. The method of claim 3, wherein filtering a subset of production process sequences affected by the update from a set of production process sequences for the in-process order comprises:
defining a selection criteria filter for the set of production process sequences;
applying the filter to the set of production process sequences to retrieve a candidate list of the subset of production process sequences; and,
confirming the candidate list.

5. The method of claim 4, wherein defining a selection criteria filter for the set of production process sequences, comprises defining a selection criteria filter for the set of production process sequences, the selection criteria filter comprising criteria selected from the group consisting of order type, part number, production status, order priority a shipping date.

6. A manufacturing production planning and routing system comprising:
a manufacturing resource planning (MRP) system configured to manage an order for a product by executing different production process sequences of production processes according to corresponding routings of the production processes;
a repository of production processes in different production sequences for producing the product in the MRP system; and,
a mass production routing engine coupled to the MRP system and the repository, the engine comprising program code enabled to update an in-process order of an initial routing of production processes both completed and uncompleted with a corresponding new routing of production processes by removing completed ones of the production processes while retaining uncompleted ones of the production processes, and to resume the in-process order with the new routing.

7. A computer program product comprising a computer usable medium embodying computer usable program code for manufacturing production planning and routing, the computer program product comprising:
computer usable program code for initiating a production process sequence to produce a product according to an initial routing;
computer usable program code for receiving a request to change the initial routing to a new routing;
computer usable program code for dynamically comparing the initial routing to the new routing;
computer usable program code for removing each production process from the new routing that had already been completed in the initial routing; and
computer usable program code for resuming the production process sequence with the new routing.

8. The computer program product of claim 7, further comprising:
computer usable program code for selecting a set of released orders from amongst a plurality of released orders; and,
computer usable program code for dynamically comparing an initial routing to a new routing, removing every production process in a corresponding production process sequence from the new routing that had already been completed in the initial routing, and resuming the production process sequence with the new routing, for each one of the selected released orders in the set.

9. A computer program product comprising a computer usable medium embodying computer usable program code for manufacturing production planning and routing, the computer program product comprising:
computer usable program code for receiving a request to update an in-process order;
computer usable program code for filtering a subset of production process sequences affected by the update from a set of production process sequences for the in-process order; and,
computer usable program code for in respect to each production process sequence in the filtered subset, comparing an initial routing of production processes for the production process sequence to a proposed new routing of production processes for the update for the production process sequence, removing each production process from the new routing that had already been completed in the initial routing, and resuming the production process sequence with the new routing.

10. The computer program product of claim 9, wherein the computer usable program code for filtering a subset of production process sequences affected by the update from a set of production process sequences for the in-process order comprises:
computer usable program code for defining a selection criteria filter for the set of production process sequences;
computer usable program code for applying the filter to the set of production process sequences to retrieve a candidate list of the subset of production process sequences; and,
computer usable program code for confirming the candidate list.

11. The computer program product of claim 10, wherein the computer usable program code for defining a selection criteria filter for the set of production process sequences, comprises computer usable program code for defining a selection criteria filter for the set of production process sequences, the selection criteria filter comprising criteria selected from the group consisting of order type, part number, production status, order priority a shipping date.
